(19) United States
(12) Patent Application Publication
(10) Pub. No.: US 2026/0284525 A1
(43) Pub. Date: Sep. 24, 2026

(54) POSITIONING SYSTEM AND POSITIONING METHOD

(71) Applicant: Sony Interactive Entertainment Inc., Tokyo (JP)

(72) Inventor: Yoshio Miyazaki, Kanagawa (JP)

(73) Assignee: Sony Interactive Entertainment Inc., Tokyo (JP)

(21) Appl. No.: 19/115,586

(22) PCT Filed: Nov. 8, 2022
(86) PCT No.: PCT/JP2022/041577

§ 371 Date: Mar. 3, 2026

(51) Int. Cl. A63F 13/428; A63F 13/212; A63F 13/235; G01S 5/14

(52) U.S. Cl. CPC A63F 13/428; A63F 13/212; A63F 13/235; G01S 5/14

(57) ABSTRACT

An object of the present disclosure is to enable an operation device to acquire the position of a user holding the operation device. A positioning system (1) includes a wearing fixture (30) that is worn by a user and is capable of communicating with an operation device (20) held by the user, and a communication device (40) that is capable of wirelessly communicating with the wearing fixture (30) and is arranged apart from the user. The wearing fixture (30) or the communication device (40) calculates the position of the wearing fixture (30) on the basis of the communication between these devices. The wearing fixture (30) transmits information related to the calculated position of the wearing fixture (30) to the operation device (20).

### TECHNICAL FIELD

The present disclosure relates to a positioning system and a positioning method.

### BACKGROUND ART

PTL 1 describes an operation device used for operating an application such as a game. The operation device is capable of performing wired or wireless communication with an information processing device that executes an application, and transmits a signal according to an operation performed by a user on the operation device to the information processing device. In addition, PTL 1 describes detection of a position (the position of a user holding the operation device) of the operation device by providing a light emitting unit for emitting light upon receiving light from a light source such as a light-emitting diode (LED) in the operation device and detecting the light of the light emitting unit through a Camera connected to the information processing device.

### CITATION LIST

### Patent Literature

[PTL 1]

JP 2022-107542A

### SUMMARY

### Technical Problem

For example, if the operation device can acquire the position of a user with the operation device, it can transmit the position thereof to the information processing device. On the basis of the position of the user received from the operation device, the information processing device can change the position of an image to be displayed on a display and an object in the image.

An object of the present disclosure is to enable an operation device to acquire the position of a user holding the operation device.

### Solution to Problem

A positioning system according to the present disclosure includes a wearing fixture that is worn by a user and is capable of communicating with an operation device held by the user, and a communication device that is capable of wirelessly communicating with the wearing fixture and is arranged apart from the user. The wearing fixture or the communication device calculates a position of the wearing fixture on the basis of the communication between the wearing fixture and the communication device. The wearing fixture transmits information related to the position of the wearing fixture calculated by the wearing fixture or the communication device to the operation device. According to this, the operation device can acquire the position of the user holding the operation device.

In addition, a wearing fixture according to the present disclosure is a wearing fixture that is capable of communicating with an operation device that is worn by a user and held by the user and a communication device arranged apart from the user, calculates a position of the wearing fixture on the basis of the communication between the wearing fixture and the communication device, and transmits information related to the calculated position of the wearing fixture to the operation device. According to this, the operation device can acquire the position of the user holding the operation device.

In addition, in a positioning method according to the present disclosure performed in a positioning system including a wearing fixture that is worn by a user and is capable of communicating with an operation device held by the user, and a communication device that is capable of wirelessly communicating with the wearing fixture and is arranged apart from the user, the wearing fixture or the communication device calculates a position of the wearing fixture on the basis of the communication between the wearing fixture and the communication device. The wearing fixture transmits information related to the position of the wearing fixture calculated by the wearing fixture or the communication device to the operation device. According to this, the operation device can acquire the position of the user holding the operation device by using the wearing fixture and the communication device.

### BRIEF DESCRIPTION OF DRAWINGS

FIG. 1 is a diagram for depicting a positioning system that is an example of an embodiment of the present disclosure.

FIG. 2A is a diagram for depicting an example of hardware configurations of an information processing device and an operation device.

FIG. 2B is a diagram for depicting an example of hardware configurations of a wearing fixture and a communication device.

FIG. 3A is a functional block diagram for depicting an example of functions of the wearing fixture, the communication device, and the information processing device.

FIG. 3B is a functional block diagram for depicting another example of functions of the wearing fixture, the communication device, and the information processing device.

FIG. 4 is a diagram for depicting an example of a method of calculating a distance between the wearing fixture and the communication device.

FIG. 5A is a diagram for depicting an example of a method of calculating an angle between the wearing fixture and the communication device.

FIG. 5B is a diagram for depicting another example of a method of calculating an angle between the wearing fixture and the communication device.

FIG. 6A is a diagram for depicting another example of a method of calculating a position of the wearing fixture.

FIG. 6B is a diagram for depicting another example of a method of calculating the position of the wearing fixture.

FIG. 7A is a diagram for depicting an example of a flow of positioning processing of the wearing fixture performed in the positioning system.

FIG. 7B is a diagram for depicting another example of a flow of the positioning processing of the wearing fixture performed in the positioning system.

### DESCRIPTION OF EMBODIMENT

### 1. System Configuration

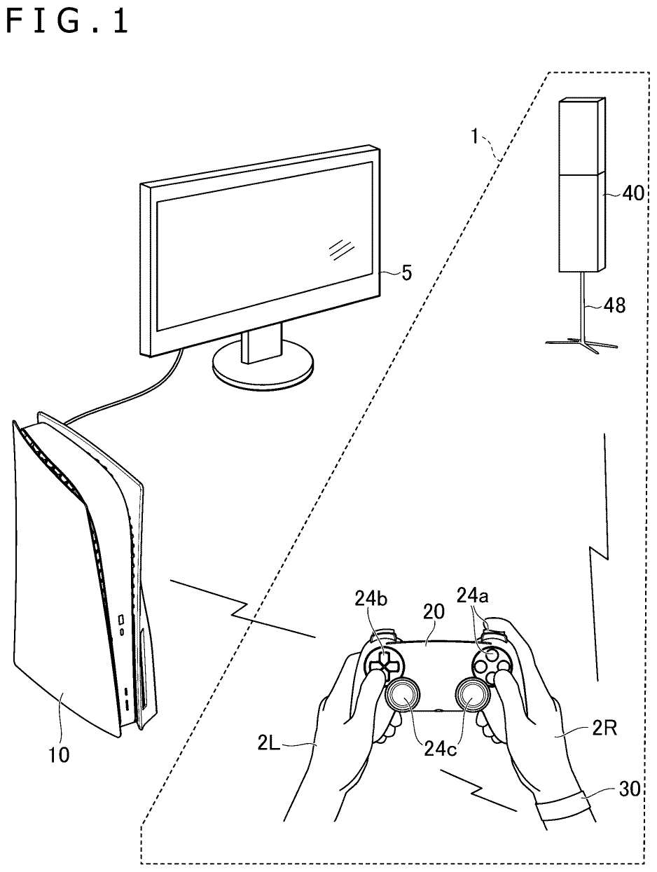

Hereinafter, an embodiment of the present disclosure will be described with reference to the drawings. FIG. 1 is a diagram for depicting a positioning system 1 that is an example of the embodiment of the present disclosure. As depicted in FIG. 1, the positioning system 1 includes, for example, an operation device 20 capable of performing wired or wireless communication with an information processing device 10 that executes an application such as a game. The positioning system 1 may include the information processing device 10 and a display device 5 such as a liquid crystal display or an organic EL (Electro Luminescence) display that is electrically connected to the information processing device 10.

The operation device 20 is held by a user and utilized for operations on applications executed by the information processing device 10. In the example depicted in FIG. 1, the operation device 20 is gripped by a left hand 2L and a right hand 2R of the user. In the example depicted in FIG. 1, the operation device 20 is a controller for a game and includes a plurality of operation buttons 24a, a cross key 24b, and operation sticks 24c. In addition to these, the operation device 20 may include a microphone, a speaker, a touch sensor for sensing contact with a finger or the like, an inertial measurement unit (IMU) for detecting an acceleration, an angular velocity, the posture (inclination) of the operation device 20, and the like.

In addition, as depicted in FIG. 1, the positioning system 1 includes a wearing fixture 30 worn by the user and a communication device 40 arranged apart from the user. The wearing fixture 30 can communicate with the operation device 20 held by the user, and the communication device 40 can wirelessly communicate with the wearing fixture 30. The communication device 40 is supported by a support section 48 such as a tripod. It should be noted that the communication between the wearing fixture 30 and the operation device 20 may be performed in a wireless or wired manner. In addition, in the example depicted in FIG. 1, the wearing fixture 30 is a band (bracelet) worn on a wrist (the wrist of the right hand 2R in the example depicted in FIG. 1) of the user. The present invention is not limited to this, and the wearing fixture 30 that the user can wear may be used, and may be, for example, a ring worn on a finger or a necklace worn on a neck.

In the positioning system 1 according to the present embodiment, as will be described later, the operation device 20 can acquire the position of the user holding the operation device 20 by using the wearing fixture 30 and the communication device 40. The operation device 20 can transmit the acquired position 4 the user to, for example, the information processing device 10 that is executing an application. The information processing device 10 can change the position of an image to be displayed on the display device 5 or an object in the image on the basis of the position of the user received from the operation device 20.

### 2. Hardware Configuration

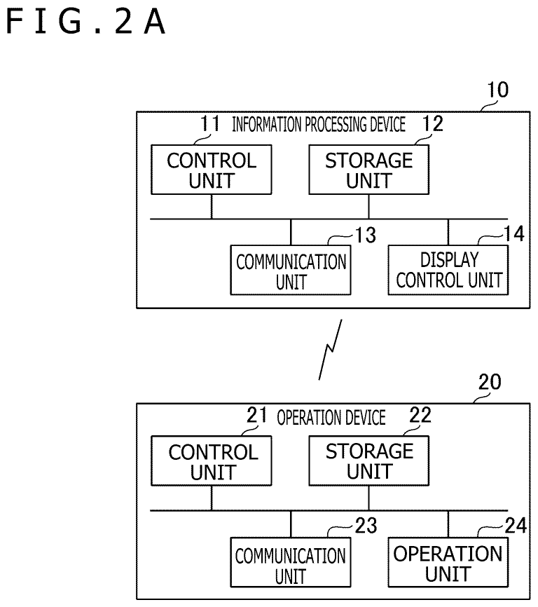

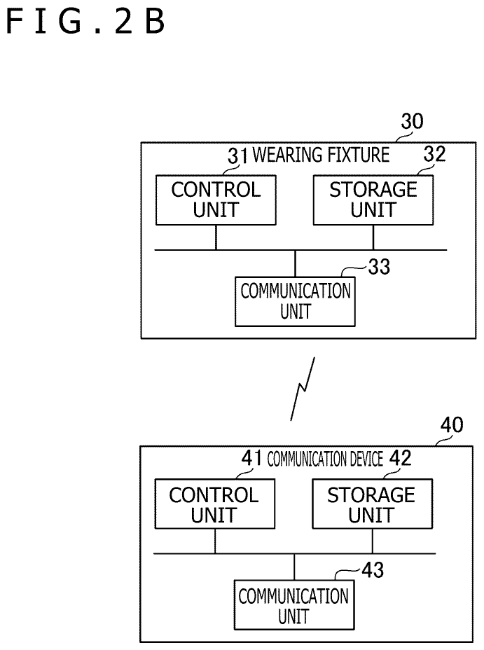

FIG. 2A is a diagram for depicting an example of hardware configurations of the information processing device 10 and the operation device 20. FIG. 2B is a diagram for depicting an example of hardware configurations of the wearing fixture 30 and the communication device 40. The information processing device 10 is, for example, a computer such as a game device, a video reproducing device, a personal computer, or a server device. As depicted in FIG. 2A, the information processing device 10 includes, for example, a control unit 11, a storage unit 12, a communication unit 13, and a display control unit 14.

In the information processing device 10, the control unit 11 is a program control processor (control device) such as a CPU (Central Processing Unit) that operates according to a program such as firmware stored in the storage unit 12. The storage unit 12 is a storage element such as a ROM (Read Only Memory) or a RAM (Random Access Memory), or an auxiliary storage device such as an SSD (Solid State Drive) or an HDD (Hard Disk Drive). The communication unit 13 is, for example, a communication device such as a network board. The display control unit 14 causes the display device 5 to display various images by transmitting video signals to the display device 5. In addition to these, the information processing device 10 may include an optical disk drive for reading an optical disk, a video output terminal such as an HDMI (High Definition Multimedia Interface) (registered trademark), a data input/output terminal such as a USB (Universal Serial Bus), and an audio input/output terminal such as a microphone, a speaker, and an earphone jack.

The operation device 20 is, for example, a controller for a game or a controller for video reproduction. As depicted in FIG. 2A, as similar to the information processing device 10, the operation device 20 includes a control unit 21 that is a processor, a storage unit 22 that is a storage device, and a communication unit 23 that is a communication device. The control unit 21 of the operation device 20 is operated, for example, according to a program (firmware and the like) stored in the storage unit 22. The communication unit 23 of the operation device 20 can perform wired or wireless communication with the communication unit 13 of the information processing device and a communication unit 33, which will be described later, of the wearing fixture 30. In addition, the operation device 20 includes an operation unit 24. According to an operation performed by the user on the operation members, the operation unit 24 outputs the contents of the operation to the control unit 21. The operation unit 24 may include, for example, the plurality of operation buttons 24a, the cross key 24b, and the operation sticks 24c depicted in FIG. 1. The operation unit 24 may include an interface such as a keyboard or a trackball, and a sensor such as a touch sensor or an IMU.

The wearing fixture 30 is worn by the user holding the operation device 20. As depicted in FIG. 2B, as similar to the information processing device 10 and the operation device 20, the wearing fixture 30 includes a control unit 31 that is a processor, a storage unit 32 that is a storage device, and a communication unit 33 that is a communication device. The control unit 31 of the wearing fixture 30 is operated, for example, according to a program (firmware and the like) stored in the storage unit 32. The communication unit 33 of the wearing fixture 30 can perform wired or wireless communication with the communication unit 23 of the operation device 20. In addition, the communication unit 33 of the wearing fixture 30 includes an antenna which will be described later, so that it can wirelessly communicate with a communication unit 43, which will be described later, of the communication device 40.

The communication device 40 is arranged at a predetermined position apart from the user. In the example depicted in FIG. 1, the communication device 40 is fixed at a predetermined position in a room where the information processing device 10 is arranged. As depicted in FIG. 2B, as similar to the wearing fixture 30, the communication device 40 includes a control unit 41 that is a processor, a storage unit 42 that is a storage device, and a communication unit 43 that is a communication device. The control unit 41 of the communication device 40 is operated, for example, according to a program (firmware and the like) stored in the storage unit 42. The communication unit 43 of the wearing fixture 40 includes an antenna which will be described later, so that it can wirelessly communicate with the communication unit 33 of the wearing fixture 30.

### 3. Functional Block

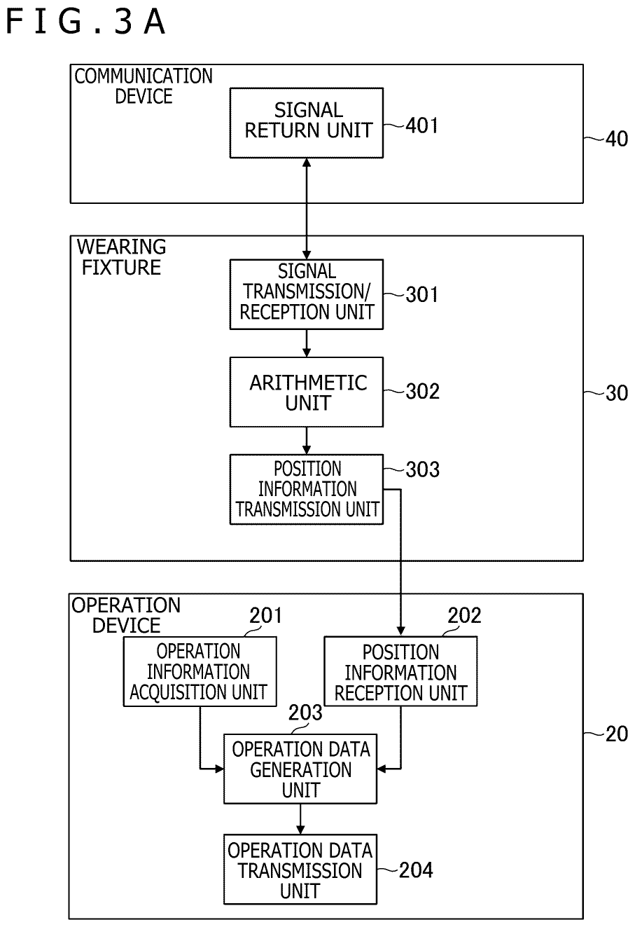

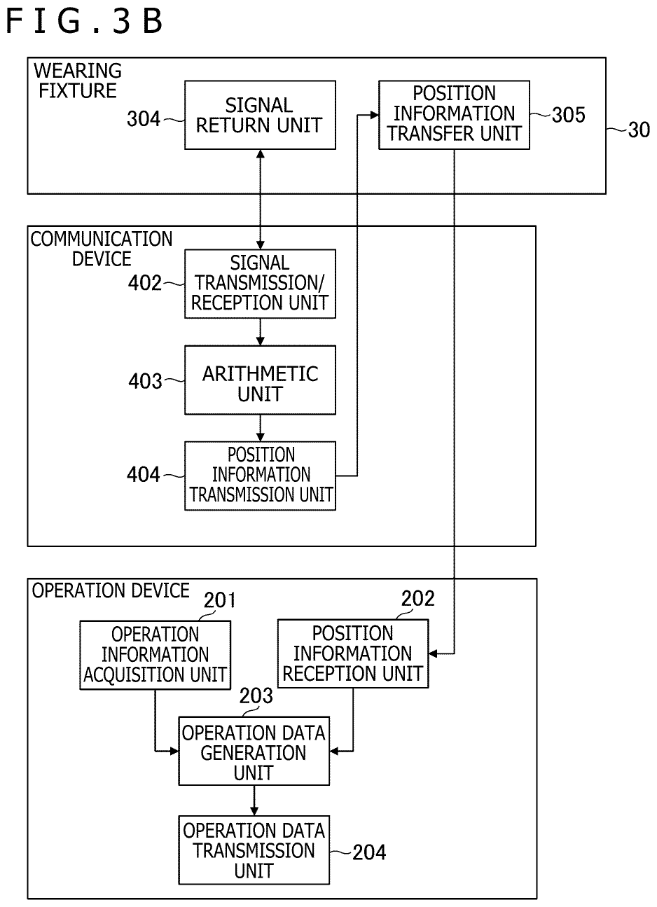

FIG. 3A is a functional block diagram for depicting an example of functions implemented in the positioning system 1. In the example depicted in FIG. 3A, the operation device 20 includes, as functions, an operation information acquisition unit 201, a position information reception unit 202, an operation data generation unit 203, and an operation data transmission unit 204. These functions may be realized mainly as the control unit 21 of the operation device 20.

The operation information acquisition unit 201 of the operation device 20 acquires information of the operation of the user on the operation unit 24 such as the plurality of operation buttons 21. The operation data generation unit 203 of the operation device 20 generates operation data indicating the operation contents of the user on the basis of the information of the operation of the user acquired by the operation information acquisition unit 201. The operation data transmission unit 204 of the operation device 20 transmits the operation data generated by the operation data generation unit 203 to the information processing device 10. The functions of the position information reception unit 202 of the operation device 20 will be described later.

In the example depicted in FIG. 3A, the wearing fixture 30 includes, as functions, a signal transmission/reception unit 301, an arithmetic unit 302, and a position information transmission unit 303. These functions may be realized mainly as the control unit 31 of the wearing fixture 30. In addition, in the example depicted in FIG. 3A, the communication device 40 includes a signal return unit 401 as a function. This function may be realized mainly as the control unit 41 of the communication device 40.

In the example depicted in FIG. 3A, the signal transmission/reception unit 301 of the wearing fixture 30 transmits a first signal (request) to the communication device 40 by using the antenna of the communication unit 33. When receiving the first signal transmitted by the signal transmission/reception unit 301 of the wearing fixture 30 by using the antenna of the communication unit 43, the signal return unit 401 of the communication device 40 transmits (replies) a second signal (response) to the wearing fixture 30. The signal transmission/reception unit 301 of the wearing fixture 30 receives the second signal transmitted by the signal return unit 401 of the communication device 40 by using the antenna of the communication unit 33.

In the example depicted in FIG. 3A, the arithmetic unit 302 of the wearing fixture 30 calculates the position of the wearing fixture 30 on the basis of the communication between the wearing fixture 30 (signal transmission/reception unit 301) and the communication device 40 (signal return unit 401). The position information transmission unit 303 of the wearing fixture 30 transmits information related to the position of the wearing fixture 30 calculated by the arithmetic unit 302 to the operation device 20. The position information reception unit 202 of the operation device 20 receives the information related to the position of the wearing fixture 30. In the example depicted in FIG. 3A, the position information reception unit 202 receives the information related to the position transmitted by the position information transmission unit 303 of the wearing fixture 30. Here, the “information related to the position of the wearing fixture 30” may be information indicating the position itself of the wearing fixture 30 or information of a position obtained by correcting the position of the wearing fixture 30. For example, when the position information transmission unit 303 transmits the information of the position of the wearing fixture 30, the operation device 20 can acquire the position of the wearing fixture 30. That is, the operation device 20 can acquire the position of the user holding the operation device 20 and wearing the wearing fixture 30.

In the example depicted in FIG. 1, the operation device 20 is operated in a state of being held by the user with the right hand 2R and the left hand 2L. The wearing fixture 30 is attached to a hand (the right hand 2R or the left hand 2L) or a wrist of the user. In this case, it can be said that the position of the operation device 20 and the position of the wearing fixture 30 are substantially the same. The position information transmission unit 303 of the wearing fixture 30 may transmit the position of the wearing fixture 30 as the position of the operation device 20.

The position information transmission unit 303 of the wearing fixture 30 may transmit the position corrected from the position of the wearing fixture 30 to the operation device 20. For example, the arithmetic unit 302 of the wearing fixture 30 may calculate the position of the chest, head, or the like of the user on the basis of the position of the wearing fixture 30.

In addition, the arithmetic unit 302 of the wearing fixture 30 may calculate the position of the operation device 20 on the basis of the position of the wearing fixture 30 and the relative position of the operation device 20 with respect to the wearing fixture 30. The control unit 21 of the operation device 20 may calculate the position the operation device 20 on the basis of the position of the wearing fixture 30 received from the wearing fixture 30 and the relative position of the operation device 20 with respect to the wearing fixture 30. Here, the “relative position of the operation device 20 with respect to the wearing fixture 30” can be calculated from, for example, the size of the hand of the user and the direction from the position of the wearing fixture 30 toward the position of the display device 5 (the direction in which the user faces). In addition, in the case where the operation device 20 includes a sensor such as an IMU, the relative position of the operation device 20 with respect to the wearing fixture 30 can be calculated further on the basis of the posture of the operation device 20. Thus, the operation device 20 can acquire the position of the operation device 20.

It should be noted that the user holds the operation device 20 in the present disclosure. Therefore, in the present disclosure, not only the position of the hand, wrist, chest, and head of the user, but also the position of the operation device 20 may be included in the “position of the user.” In addition, the acquisition of the position of the user by the operation device 20 may include not only acquisition of the position of the wearing fixture 30 by the operation device 20, but also acquisition of the position of the operation device 20.

FIG. 3B is a functional block diagram for depicting another example of functions implemented in the positioning system 1. In the example depicted in FIG. 3B, the wearing fixture 30 includes, as functions, a signal return unit 304 and a position information transfer unit 305. These functions may also be realized mainly as the control unit 31 of the wearing fixture 30 as similar to the functions of the wearing fixture 30 depicted in FIG. 3A. In addition, in the example depicted in FIG. 3B, the communication device 40 includes, as functions, a signal transmission/reception unit 402, an arithmetic unit 403, and a position information transmission unit 404. These functions may also be realized mainly as the control unit 41 of the communication device 40 as similar to the functions of the communication device 40 depicted in FIG. 3A.

In the example depicted in FIG. 3B, the signal transmission/reception unit 402 of the communication device 40 transmits a first signal (request) to the wearing fixture 30 by using the antenna of the communication unit 43. When receiving the first signal by using the antenna of the communication unit 33, the signal return unit 304 of the wearing fixture 30 transmits (replies) a second signal (response). The signal transmission/reception unit 402 of the communication device 40 receives the second signal by using the antenna of the communication unit 43.

In the example depicted in FIG. 3B, the arithmetic unit 403 of the communication device 40 calculates the position of the wearing fixture 30 on the basis of the communication between the communication device 40 (signal transmission/reception unit 402) and the wearing fixture 30 (signal return unit 304) as similar to the arithmetic unit 302 depicted in FIG. 3A. The position information transmission unit 404 of the communication device 40 transmits information related to the position of the wearing fixture 30 calculated by the arithmetic unit 403 to the wearing fixture 30. The position information transfer unit 305 of the wearing fixture 30 receives the information related to the position of the wearing fixture 30 and transmits (transfers) the information to the operation device 20. Then, the position information reception unit 202 receives the information related to the position transferred by the position information transfer unit 305 of the wearing fixture 30. For example, when the position information transmission unit 404 and the position information transfer unit 305 transmit the information of the position of the wearing fixture 30, the operation device 20 can acquire the position of the wearing fixture 30. The operation device 20 can acquire the position of the user holding the operation device 20 and wearing the wearing fixture 30. In addition, the position information transmission unit 404 and the position information transfer unit 305 may transmit the position of the operation device 20 corrected from the position of the wearing fixture 30 to the operation device 20. Accordingly, the operation device 20 can acquire the position of the operation device 20.

In the examples depicted in FIG. 3A and FIG. 3B, the operation data generation unit 203 of the operation device 20 generates operation data including the information related to the position of the wearing fixture 30 on the basis of the information of the operation of the user acquired by the operation information acquisition unit 201 and the information (the information of the position of the wearing fixture 30 or the information of the position corrected on the basis of the position of the wearing fixture 30) related to the position of the wearing fixture 30 received by the position information reception unit 202. In this case, the information related to the position of the wearing fixture 30 calculated by the wearing fixture 30 or the communication device 40 is the information transmitted to the information processing device 10 together with the operation data indicating the operation contents on the operation device 20. The operation data transmission unit 204 of the operation device 20 transmits the operation data generated by the operation data generation unit 203 to the information processing device 10. Accordingly, the information processing device 10 can acquire the information such as the position (that is, the position of the user wearing the wearing fixture 30) of the wearing fixture 30 and the position of the operation device 20 corrected from the position of the wearing fixture 30 together with the operation of the user on the operation device 20. The information processing device 10 can change the position of an image to be displayed on the display device 5 or an object in the image on the basis of the acquired information of the position of the user and the like.

The operation data generation unit 203 of the operation device 20 generates the operation data by including the information (the information of the position of the wearing fixture 30 or the information of the position corrected on the basis of the position of the wearing fixture 30) related to the position of the wearing fixture 30 received by the position information reception unit 202 in, for example, a data area preliminarily defined in the operation data. In this case, the information related to the position of the wearing fixture 30 calculated by the wearing fixture 30 or the communication device 40 is the information transmitted to the information processing device 10 in a state included in the data area preliminarily defined in the operation data. In operation data generated by a conventional operation device, for example, a free area is provided. The operation data generation unit 203 may store the information related to the position of the wearing fixture 30 in the free area to generate the operation data. This makes it possible to transmit the information related to the position of the wearing fixture 30 without changing the standard of the conventional operation data. For example, the operation data including the information related to the position of the wearing fixture 30 can be generated only by updating a program such as firmware stored in the conventional operation device.

### 4. Position Calculation Method (1)

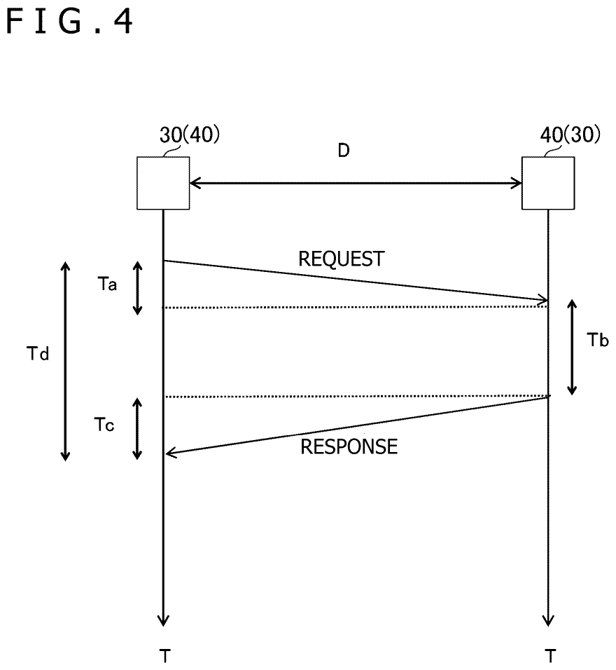

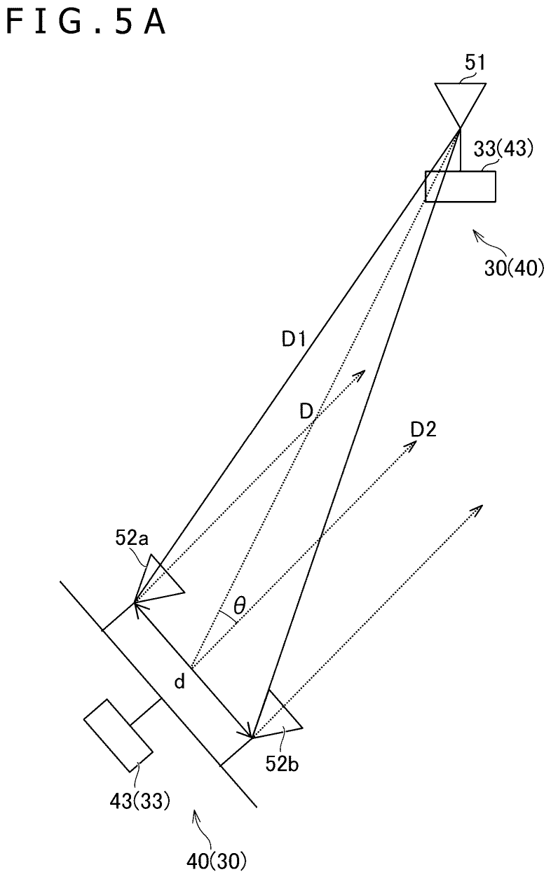

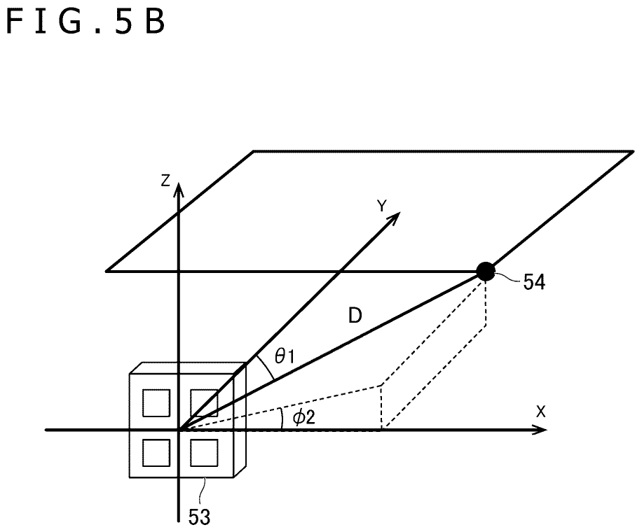

Processing of the arithmetic unit 302 of the wearing fixture 30 or the arithmetic unit 403 of the communication device 40 (hereinafter, also referred to simply as the arithmetic unit 302 or 403) for calculating the position of the wearing fixture 30 will be described below. The arithmetic unit 302 or 403 calculates, for example, the distance and angle (the angle between the direction in which one device of the wearing fixture 30 and the communication device 40 faces and the direction from the one device to the other device) between the wearing fixture 30 and the communication device 40, and calculates the position of the wearing fixture 30 on the basis of the calculated distance and angle. FIG. 4 is a diagram for depicting an example of a method of calculating the distance between the wearing fixture 30 and the communication device 40. FIG. 5A is a diagram for depicting an example of a method of calculating the distance and angle. FIG. 5B is a diagram for depicting another example of a method of calculating the distance and angle.

The arithmetic unit 302 or 403 calculates the distance between the wearing fixture 30 and the communication device 40 on the basis of a period until a signal reciprocates between the wearing fixture 30 and the communication device 40. In the example depicted in FIG. 4, T indicates a time lapse. Ta indicates, for example, a period from the transmission of the first signal (request) by the signal transmission/reception unit 301 of the wearing fixture 30 to the reception of the signal by the signal return unit 401 of the communication device 40. Tb indicates, for example, a period from the reception of the first signal by the signal return unit 401 of the communication device 40 to the transmission (reply) of the second signal (response). Tc indicates, for example, a period from the transmission of the second signal by the signal return unit 401 of the communication device 40 to the reception of the signal by the signal transmission/reception unit 301 of the wearing fixture 30. Td indicates, for example, a period from the transmission of the first signal to the reception of the second signal by the signal transmission/reception unit 301 of the wearing fixture 30, that is, a series of periods from Ta to Tc. It should be noted that the above description is the description of the example of the functional blocks depicted in FIG. 3A, but is the description of the example of the functional blocks depicted in FIG. 3B by replacing the signal transmission/reception unit 301 of the wearing fixture 30 with the signal transmission/reception unit 402 of the communication device 40 and replacing the signal return unit 401 of the communication device 40 with the signal return unit 304 of the wearing fixture 30.

In the example depicted in FIG. 4, a distance D between the wearing fixture 30 and the communication device 40 can be calculated by a formula such as D=light speed*(Ta+Tc)/2 or D=light speed*(Td−Tb)/2. It should be noted that “*” indicates a multiplication symbol.

The signal return unit 401 or the signal return unit 304 (hereinafter, also referred to simply as the signal return unit 401 or 304) may transmit, for example, a period of Tb (a numerical value such as the number of seconds) added to the second signal (response). In addition, the signal return unit 401 or 304 may transmit, for example, a time when the first signal is received and a time when the second signal is transmitted in addition to the second signal. Thus, the arithmetic unit 302 or 403 can specify the periods of Ta and Tc or the periods of Td and Tb on the basis of the information such as the period and time added to the second signal, the time when the first signal is transmitted, and the time when the second signal is received, and can calculate the distance D between the wearing fixture 30 and the communication device 40. It should be noted that if the period of Tb is known, the signal return unit 401 or 304 may transmit the second signal without adding the information of the period and time.

In the example depicted in FIG. 5A, the communication unit 33 of the wearing fixture 30 includes an antenna 51. In addition, the communication unit 43 of the communication device 40 includes a first antenna 52a and a second antenna 52b capable of wirelessly communicating with the antenna 51. On the contrary, the antenna 51 may be included in the communication unit 43 of the communication device 40, and the first antenna 52a and the second antenna 52b may be included in the communication unit 33 of the wearing fixture 30. The first antenna 52a and the second antenna 52b face in the same direction (the direction indicated by dotted arrows in FIG. 5A). The first antenna 52a and the second antenna 52b are arranged at a predetermined interval d in a direction perpendicular to the direction in which these antennas face.

As depicted in FIG. 5A, for example, when the communication device 40 does not face the wearing fixture 30, more specifically, when the position of the antenna 51 of the wearing fixture 30 is deviated from the direction in which the first antenna 52a and the second antenna 52b of the communication device 40 face, there is a difference between a distance D1 between the antenna 51 and the first antenna 52a and a distance D2 between the antenna 51 and the second antenna 52b.

Here, the arithmetic unit 302 or 403 may obtain the distance D between the wearing fixture 30 and the communication device 40 on the basis of a first period T1 until a signal reciprocates between the first antenna 52a and the antenna 51 and a second period T2 until a signal reciprocates between the second antenna 52b and the antenna 51. For example, the arithmetic unit 302 or 403 may calculate the distance D1 between the first antenna 52a and the antenna 51 on the basis of the first period T1, may calculate the distance D2 between the second antenna 52b and the antenna 51 on the basis of the second period T2, and may calculate the average value of the distances D1 and D2 as the distance D between the wearing fixture 30 and the communication device 40.

In addition, the arithmetic unit 302 or 403 may calculate an angle (azimuth angle) θ between the direction in which the communication device 40 (or the wearing fixture 30) faces and the direction from the communication device 40 toward the wearing fixture 30 on the basis of the first period T1 until a signal reciprocates between the first antenna 52a and the antenna 51 and the second period T2 until a signal reciprocates between the second antenna 52b and the antenna 51. The angle θ can be calculated by, for example, a formula of θ=arccos((ψλ)/2πd). Here, “ψ” indicates the phase difference between the signals received by the first antenna 52a and the second antenna 52b, “λ” indicates the wavelength of the signal, “π” indicates the ratio of the circumference of a circle, and “d” indicates the distance between the first antenna 52a and the second antenna 52b (see FIG. 5A). In the example depicted in FIG. 5A, the arithmetic unit 302 or 403 calculates the position of the wearing fixture 30 on the basis of the distance D and the angle θ calculated as described above.

As depicted in FIG. 5B, the communication unit 43 (or the communication unit 33 of the wearing fixture 30) of the communication device 40 may include an array antenna 53. The array antenna 53 includes a first set of antennas arranged at an interval in the vertical direction (Z-axis direction in FIG. 5B) and a second set of antennas arranged at an interval in the horizontal direction (X-axis direction in FIG. 5B). For each of a plurality of antennas included in the array antenna 53, the arithmetic unit 302 or 403 may acquire a period until a signal reciprocates between the antenna and the antenna 54 included in the communication unit 33 (or the communication unit 43 of the communication device 40) of the wearing fixture 30, and may calculate, on the basis of the plurality of periods, the distance D between the wearing fixture 30 and the communication device 40, a azimuth angle θ1 of the angle between the direction in which the communication device 40 (or the wearing fixture 30) faces and the direction from the communication device 40 toward the wearing fixture 30, and an elevation angle θ2. As described above, by using the array antenna 53 to measure the period in which a signal reciprocates in each antenna, the elevation angle θ2 can be calculated in addition to the azimuth angle θ1. In the example depicted in FIG. 5B, the arithmetic unit 302 or 403 can calculate the position of the wearing fixture 30 on the basis of the distance D, the azimuth angle θ1, and the elevation angle θ2 calculated as described above.

### 4. Position Calculation Method (2)

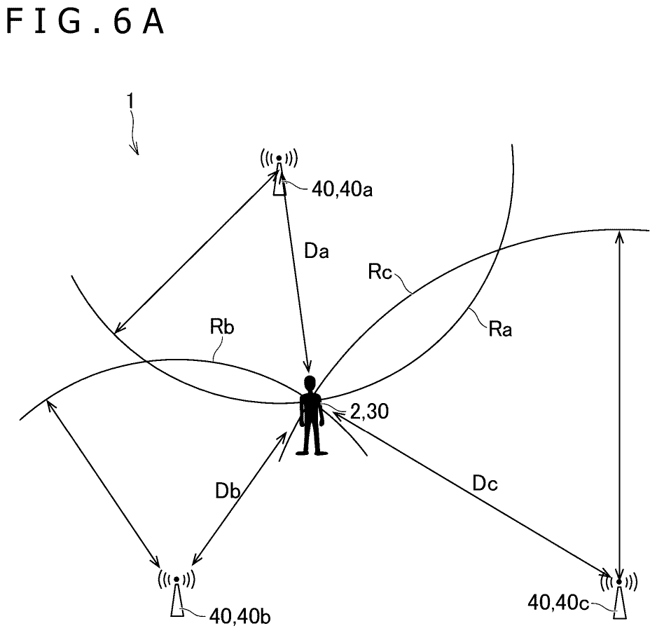

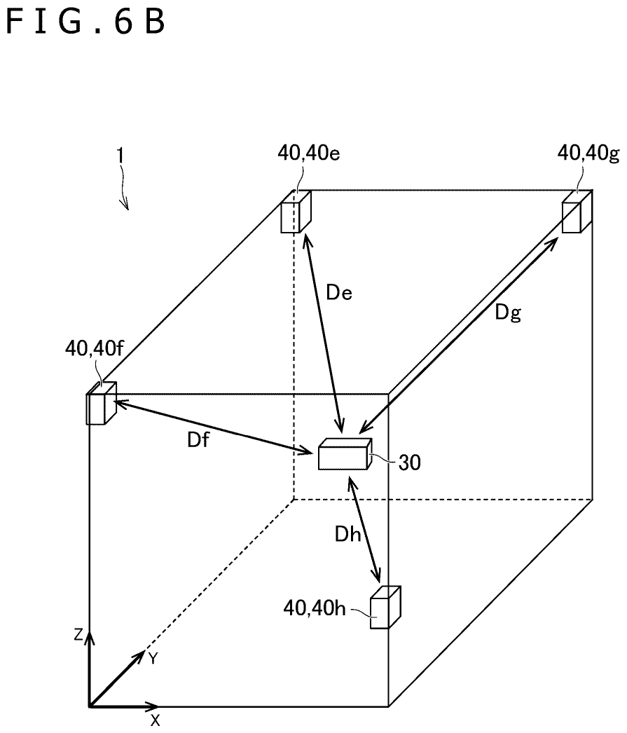

FIG. 6A is a diagram for depicting another example of a method of calculating the position of the wearing fixture 30. In the example depicted in FIG. 6A, the positioning system 1 includes a plurality of communication devices 40 (three communication devices 40a to 40c) arranged at positions different from each other. The communication devices 40a to 40c include the above-described communication units 43, and are capable of wirelessly communicating with the wearing fixture 30.

In the example depicted in FIG. 6A, the arithmetic unit 302 or the arithmetic unit 403 included in each of the communication devices 40a to 40c calculates the distance between the wearing fixture 30 and the communication device 40 on the basis of a period until a signal reciprocates between the wearing fixture 30 and the communication device 40 for each of the plurality of communication devices 40a to 40c. The arithmetic unit 302 or 403 calculates a distance Da from the wearing fixture 30 worn by a user 2 to the communication device 40a, a distance Db from the wearing fixture 30 to the communication device 40b, and a distance Dc from the wearing fixture 30 to the communication device 40b. As depicted in FIG. 6A, the position where an arc Ra whose radius is the distance Da from the communication device 40a, an arc Rb whose radius is the distance Db from the communication device 40b, and an arc Rc whose radius is the distance Dc from the communication device 40c overlap with each other is the position of the wearing fixture 30. Therefore, in the example depicted in FIG. 6A, the arithmetic unit 302 or 403 calculates the position of the wearing fixture 30 on the basis of the plurality of calculated distances Da to Dc.

FIG. 6B is a diagram for depicting another example of a method of calculating the position of the wearing fixture 30. In the example depicted in FIG. 6B, the positioning system 1 includes a plurality of communication devices 40 (four communication devices 40e to 40h) as similar to the example depicted in FIG. 6A. The communication devices 40e to 40h include the communication units 43, and are capable of wirelessly communicating with the wearing fixture 30. The communication devices 40e to 40h are arranged at positions different from each other. In addition, in the height direction (Z-axis direction in FIG. 6B), one communication device 40h is arranged at a position different from the other communication devices 40e to 40g.

In the example depicted in FIG. 6B, the arithmetic unit 302 or the arithmetic unit 403 included in each of the communication devices 40e to 40h calculates the distance between the wearing fixture 30 and the communication device 40 on the basis of a period until a signal reciprocates between the wearing fixture 30 and the communication device 40 for each of the plurality of communication devices 40e to 40h. The arithmetic unit 302 or 403 calculates a distance De from the wearing fixture 30 to the communication device 40e, a distance Df from the wearing fixture 30 to the communication device 40f, a distance Dg from the wearing fixture 30 to the communication device 40g, and a distance Dh from the wearing fixture 30 to the communication device 40h. Here, the position where the surface of a sphere whose radius is the distance De from the communication device 40e, the surface of a sphere whose radius is the distance Df from the communication device 40f, the surface of a sphere whose radius is the distance Dg from the communication device 40g, and the surface of a sphere whose radius is the distance Dh from the communication device 40h overlap with each other is the position of the wearing fixture 30. In the example depicted in FIG. 6B, the arithmetic unit 302 or 403 can calculate the position of the wearing fixture 30 on the basis of the plurality of calculated distances De to Dh.

### 5. Flowchart

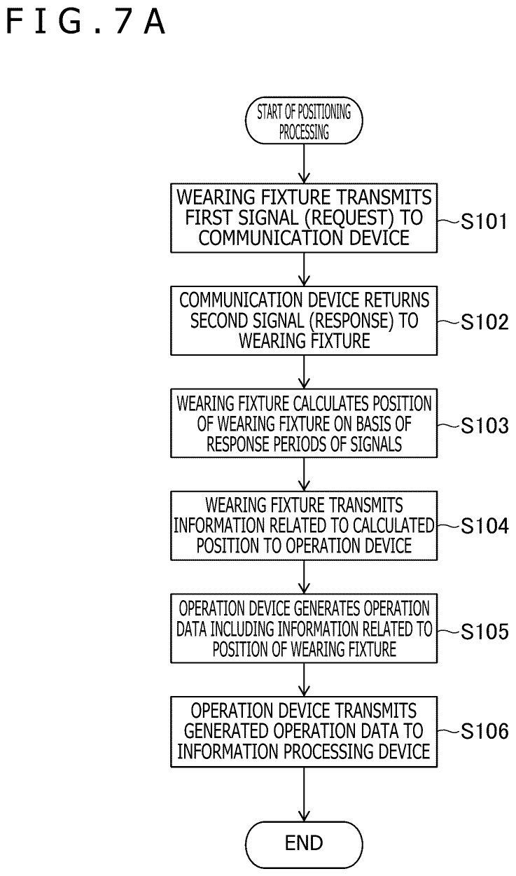

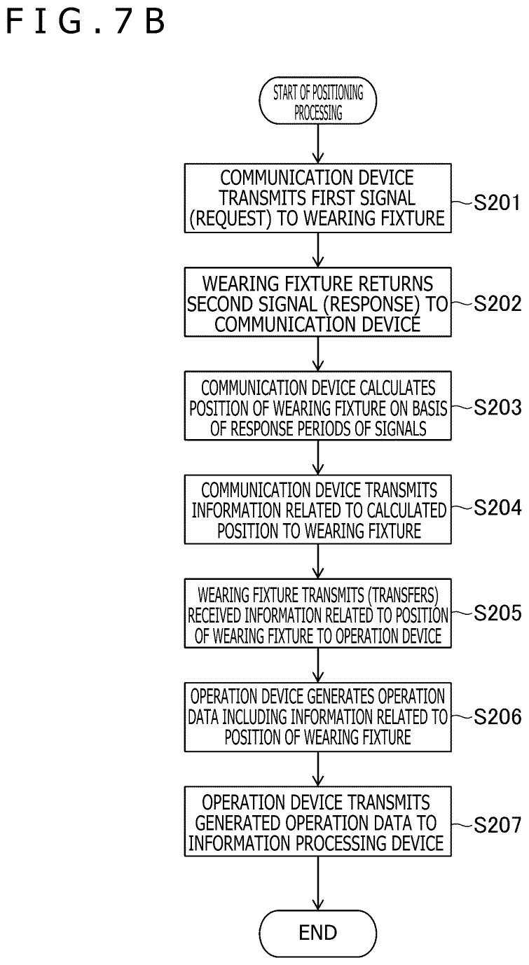

FIG. 7A is a diagram for depicting an example of a flow of positioning processing of the wearing fixture 30 performed in the positioning system 1. The positioning processing depicted in FIG. 7A is executed by each function of the functional block diagram depicted in FIG. 3A. The positioning processing depicted in FIG. 7A and FIG. 7B, which will be described later, may be repeatedly executed during, for example, a period in which the information processing device 10 executes an application such as a game.

First, as depicted in FIG. 7A, the signal transmission/reception unit 301 of the wearing fixture 30 transmits a first signal (request) to the communication device 40 (Step S101). In the case where the positioning system 1 includes a plurality of communication devices 40 (for example, the communication devices 40a to 40c depicted in FIG. 6A), the signal transmission/reception unit 301 transmits the first signal to the plurality of communication devices 40 in Step S101.

Next, the signal return unit 401 of the communication device 40 having received the first signal (request) transmitted in Step S101 returns a second signal (response) to the wearing fixture 30 (Step S102). Next, the arithmetic unit 302 of the wearing fixture 30 calculates the position of the wearing fixture 30 on the basis of the response periods of the first signal and the second signal transmitted and received in Step S101 and Step S102 (Step S103).

In Step S103, as depicted in, for example, FIG. 4, FIG. 5A, and FIG. 5B, the arithmetic unit 302 of the wearing fixture 30 calculates the distance and angle (angle between the direction in which one device of the wearing fixture 30 and the communication device 40 faces and the direction from the one device to the other device) between the wearing fixture 30 and the communication device 40 on the basis of periods (a plurality of periods until a signal reciprocates through a plurality of antennas included in the wearing fixture 30 or the communication device 40) until a signal reciprocates between the wearing fixture 30 and the communication device 40, and calculates the position of the wearing fixture 30 on the basis of the calculated distance and angle.

In addition, in Step S103, in the case where the positioning system 1 includes a plurality of communication devices 40, the arithmetic unit 302 of the wearing fixture may calculate, for each of the plurality of communication devices 40, the distance between the wearing fixture 30 and the communication device 40 on the basis of a period until a signal reciprocates between the wearing fixture 30 and the communication device 40, as depicted in, for example, FIG. 4, FIG. 6A, and FIG. 6B. Then, the position of the wearing fixture 30 may be calculated on the basis of the plurality of calculated distances.

Next, the position information transmission unit 303 of the wearing fixture 30 transmits the information related to the position of the wearing fixture 30 calculated in Step S103 to the operation device 20 (Step S104). The position information reception unit 202 of the operation device 20 receives the information related to the position of the wearing fixture 30 transmitted in Step S104. In Step S103, the position information transmission unit 303 may transmit the information of the position of the wearing fixture 30 to the operation device 20. Accordingly, the operation device 20 can acquire the position of the wearing fixture 30. The operation device 20 can acquire the position of the user holding the operation device 20 and wearing the wearing fixture 30. In addition, in Step S103, the position information transmission unit 303 may transmit, to the operation device 20, information (for example, information corrected to the position of the operation device 20) of the position corrected on the basis of the position of the wearing fixture 30 and the relative position of the operation device 20 with respect to the wearing fixture 30. Accordingly, the operation device 20 can acquire the position of the operation device 20.

Next, the operation data generation unit 203 of the operation device 20 generates operation data including the information related to the position of the wearing fixture 30 (Step S105). Finally, the operation data transmission unit 204 of the operation device 20 transmits the operation data generated in Step S105 to the information processing device (Step S106), and terminates the processing.

In Step S105, the operation data generation unit 203 of the operation device 20 generates the operation data including the information related to the position of the wearing fixture 30 on the basis of the information of the operation of the user acquired by the operation information acquisition unit 201 and the information related to the position of the wearing fixture 30 received by the position information reception unit 202. The operation data generation unit 203 may generate, for example, the operation data including the information of the position of the wearing fixture 30. By receiving the operation data transmitted in Step S106, the information processing device 10 can acquire the position (that is, position of the user wearing the wearing fixture 30) of the wearing fixture 30 together with the operation of the user on the operation device 20.

In addition, in Step S105, the operation data generation unit 203 may calculate the position of the operation device 20 on the basis of the position of the wearing fixture 30 and the relative position of the operation device 20 with respect to the wearing fixture 30, and may generate the operation data including the information of the calculated position of the operation device 20. Even in the case where the position information transmission unit 303 transmits the information corrected to the position of the operation device 20 in Step S104, the operation data generation unit 203 may generate the operation data including the information of the position of the operation device 20. The information processing device 10 can acquire the position of the operation device 20 by receiving the operation data transmitted in Step S106.

In Step S105, the operation data generation unit 203 of the operation device 20 generates the operation data by including the information of the position received by the position information reception unit 202 or the information regarding the position corrected from the position in, for example, a data area preliminarily defined in the operation data. The operation data generation unit 203 may store the information related to the position of the wearing fixture 30 in, for example, a free area defined in the conventional operation data to generate the operation data. This makes it possible to transmit the information related to the position of the wearing fixture 30 to the information processing device 10 without changing the standard of the conventional operation data.

FIG. 7B is a diagram for depicting another example of a flow of the positioning processing of the wearing fixture 30 performed in the positioning system 1. The positioning processing depicted in FIG. 7B is executed by each function of the functional block diagram depicted in FIG. 3B.

First, as depicted in FIG. 7B, the signal transmission/reception unit 402 of the communication device 40 transmits a first signal (request) to the wearing fixture 30 (Step S201). In the case where the positioning system 1 includes a plurality of communication devices 40 (for example, the communication devices 40a to 40c depicted in FIG. 6A), each of the plurality of communication devices 40 transmits the first signal to the wearing fixture 30 in Step S201.

Next, the signal return unit 304 of the wearing fixture 30 having received the first signal (request) transmitted in Step S201 returns a second signal (response) to the communication device 40 (Step S202). Next, the arithmetic unit 403 of the communication device 40 calculates the position of the wearing fixture 30 on the basis of the response periods of the first signal and the second signal transmitted and received in Step S201 and Step S202 (Step S203).

In Step S203, the arithmetic unit 403 of the communication device 40 may calculate the position of the wearing fixture 30 by calculating the distance and angle between the wearing fixture 30 and the communication device 40 as similar to Step S103 of FIG. 7A. In addition, in Step S203, in the case where the positioning system 1 includes a plurality of communication devices 40, the arithmetic unit 403 of each communication device 40 may calculate the distance between the communication device 40 and the wearing fixture 30 on the basis of a period until a signal reciprocates between the communication device 40 and the wearing fixture 30. Then, one communication device 40 may acquire (receive) the distance calculated by each communication device 40 through the communication unit 43, and the arithmetic unit 403 of the communication device 40 may calculate the position of the wearing fixture 30 on the basis of a plurality of acquired distances.

Next, the position information transmission unit 404 of the communication device 40 transmits the information related to the position of the wearing fixture 30 calculated in Step S203 to the wearing fixture 30 (Step S204). Next, the position information transfer unit 305 of the wearing fixture 30 receives the information related to the position of the wearing fixture 30 transmitted in Step S204, and transmits (transfers) it to the operation device 20 (Step S205). In Step S203 and Step S204, the position information transmission unit 404 and the position information transfer unit 305 may transmit the information of the position of the wearing fixture 30. In addition, in Step S203 and Step S204, the position information transmission unit 404 and the position information transfer unit 305 may transmit information (for example, information of the position of the operation device 20) of the position corrected on the basis of the position of the wearing fixture 30.

The position information reception unit 202 of the operation device 20 receives the information related to the position of the wearing fixture 30 transmitted in Step S205. For example, when the position information reception unit 202 receives the information related to the position of the wearing fixture 30, the operation device 20 can acquire the position (that is, the position of the user wearing the wearing fixture 30) of the wearing fixture 30. In addition, when the position information reception unit 202 receives the information of the position of the operation device 20 corrected from the position of the wearing fixture 30, the operation device 20 can acquire the position of the operation device 20.

Next, the operation data generation unit 203 of the operation device 20 generates operation data including the information related to the position of the wearing fixture 30 (Step S206). Finally, the operation data transmission unit 204 of the operation device 20 transmits the operation data generated in Step S206 to the information processing device (Step S207), and terminates the processing. By receiving the operation data transmitted in Step S207, the information processing device 10 can acquire the position (that is, the position of the user wearing the wearing fixture 30) of the wearing fixture 30.

### 6. Summary

(1) As described above, a positioning system 1 described in the present disclosure includes a wearing fixture 30 that is worn by a user and is capable of communicating with an operation device 20 held by the user, and a communication device 40 that is capable of wirelessly communicating with the wearing fixture 30 and is arranged apart from the user. The wearing fixture 30 or the communication device 40 calculates the position of the wearing fixture 30 on the basis of the communication between the wearing fixture 30 and the communication device 40. The wearing fixture 30 transmits information related to the position of the wearing fixture 30 calculated by the wearing fixture 30 or the communication device 40 to the operation device 20. According to this, the operation device 20 can acquire the position of the user holding the operation device 20.

(9) In addition, a wearing fixture 30 described in the present disclosure is capable of communicating with an operation device 20 that is worn by a user and held by the user and a communication device 40 arranged apart from the user. The wearing fixture 30 calculates the position of the wearing fixture 30 on the basis of the communication between the wearing fixture 30 and the communication device 40, and transmits information related to the calculated position of the wearing fixture 30 to the operation device 20. According to this, the operation device 20 can acquire the position of the user holding the operation device 20.

(10) In addition, in a positioning method described in the present disclosure and is performed in a positioning system 1 including a wearing fixture 30 that is worn by a user and is capable of communicating with an operation device 20 held by the user, and a communication device 40 that is capable of wirelessly communicating with the wearing fixture 30 and is arranged apart from the user, the wearing fixture 30 or the communication device 40 calculates the position of the wearing fixture 30 on the basis of the communication between the wearing fixture 30 and the communication device 40. Then, the wearing fixture 30 transmits information related to the position of the wearing fixture 30 calculated by the wearing fixture 30 or the communication device 40 to the operation device 20. According to this, the operation device 20 can acquire the position of the user holding the operation device 20 by using the wearing fixture 30 and the communication device 40.

(2) In the positioning system 1 according to (1), the operation device 20 may be operated in a state of being held by the user with hands. The wearing fixture 30 may be attached to a hand or a wrist of the user. The operation device 20 may acquire the position of the operation device 20 on the basis of information related to the position of the wearing fixture 30. According to this, the operation device 20 can acquire the position of the operation device 20.

(3) In the positioning system 1 according to (1), one device of the wearing fixture 30 and the communication device 40 includes a first antenna 52a and a second antenna 52b capable of wirelessly communicating with the other device. The wearing fixture 30 or the communication device 40 may calculate a distance D between the wearing fixture 30 and the communication device 40 and an angle θ between the direction in which the one device faces and the direction from the one device toward the other device on the basis of a first period T1 until a signal reciprocates between the first antenna 52a and the other device and a second period T2 until a signal reciprocates between the second antenna 52b and the other device. The wearing fixture 30 or the communication device 40 may calculate the position of the wearing fixture 30 on the basis of the calculated distance D and angle θ.

(4)

The positioning system 1 according to (1) may include a plurality of communication devices 40 arranged at positions different from each other. Each of the plurality of communication devices 40 may be capable of wirelessly communicating with the wearing fixture 30. The wearing fixture 30 or at least one of the plurality of communication devices 40 may calculate the distance between the wearing fixture 30 and the communication device 40 on the basis of a period until a signal reciprocates between the wearing fixture 30 and the communication device 40 for each of the plurality of communication devices 40. The wearing fixture 30 or at least one of the plurality of communication devices 40 may calculate the position of the wearing fixture 30 on the basis of a plurality of the calculated distances.

(5) In the positioning system 1 according to any one of (1) to (4), the wearing fixture 30 may calculate the position of the wearing fixture 30 on the basis of the communication between the wearing fixture 30 and the communication device 40, and may transmit information related to the calculated position of the wearing fixture 30 to the operation device 20.

(6) In the positioning system 1 according to any one of (1) to (4), the communication device 40 may calculate the position of the wearing fixture 30 on the basis of the communication between the wearing fixture 30 and the communication device 40, and may transmit information related to the calculated position of the wearing fixture 30 to the wearing fixture 30. The wearing fixture 30 may transmit the information related to the position of the wearing fixture 30 received from the communication device 40 to the operation device 20.

(7) In the positioning system 1 according to any one of (1) to (6), the information related to the position of the wearing fixture 30 calculated by the wearing fixture 30 or the communication device 40 may be information transmitted to an information processing device 10 together with operation data indicating the contents of an operation on the operation device 20. Thus, the information processing device 10 can acquire the position of the user holding the operation device 20.

(8) In the positioning system 1 according to (7), the information related to the position of the wearing fixture 30 calculated by the wearing fixture 30 or the communication device 40 is information transmitted to the information processing device 10 in a state included in a data area preliminarily defined in the operation data.

The present disclosure is not limited to the above embodiment. For example, examples modified from the above embodiment may be also included in the technical range of the present disclosure.

For example, an example in which one of the wearing fixture 30 and the communication device 40 has the arithmetic unit (the arithmetic unit 302 or the arithmetic unit 403) has been described in the embodiment, but each of the wearing fixture 30 and the communication device 40 may have the arithmetic unit. For example, the arithmetic unit 302 of the wearing fixture 30 may calculate the distance and angle between the wearing fixture 30 and the communication device 40, and the arithmetic unit 403 of the communication device 40 may calculate the position of the wearing fixture 30 on the basis of the distance and angle calculated in the wearing fixture 30.

In addition, in the case where the positioning system 1 includes a plurality of communication devices 40, the arithmetic unit 403 of each communication device 40 may calculate the distance from the communication device 40 to the wearing fixture 30, and the arithmetic unit 302 of the wearing fixture 30 or the arithmetic unit 403 of one communication device 40 may calculate the distance from each communication device 40 to the wearing fixture 30. In this case, the arithmetic unit 302 of the wearing fixture 30 or the arithmetic unit 403 of one communication device 40 may calculate the position of the wearing fixture 30 on the basis of a plurality of calculated distances.

1. A positioning system comprising:
a wearing fixture that is worn by a user and is capable of communicating with an operation device held by the user; and
a communication device that is capable of wirelessly communicating with the wearing fixture and is arranged apart from the user, wherein
the wearing fixture or the communication device calculates a position of the wearing fixture on a basis of the communication between the wearing fixture and the communication device, and the wearing fixture transmits information related to the position of the wearing fixture calculated by the wearing fixture or the communication device to the operation device.

2. The positioning system, wherein
the operation device is an operation device operated in a state of being held by the user with hands,
the wearing fixture is attached to a hand or a wrist of the user, and
the operation device acquires a position of the operation device on a basis of information related to the position of the wearing fixture.

3. The positioning system according to claim 1, wherein
one device of the wearing fixture and the communication device includes a first antenna and a second antenna capable of wirelessly communicating with the other device,
the wearing fixture or the communication device calculates a distance between the wearing fixture and the communication device and an angle between a direction in which the one device faces and a direction from the one device toward the other device on a basis of a first period until a signal reciprocates between the first antenna and the other device and a second period until a signal reciprocates between the second antenna and the other device, and
the wearing fixture or the communication device calculates the position of the wearing fixture on a basis of the calculated distance and angle.

4. The positioning system according to claim 1, wherein
a plurality of the communication devices arranged at positions different from each other is provided,
each of the plurality of communication devices is capable of wirelessly communicating with the wearing fixture,
the wearing fixture or at least one of the plurality of communication devices calculates a distance between the wearing fixture and the communication device on a basis of a period until a signal reciprocates between the wearing fixture and the communication device for each of the plurality of communication devices, and
the wearing fixture or at least one of the plurality of communication devices calculates the position of the wearing fixture on a basis of a plurality of the calculated distances.

5. The positioning system according to claim 1, wherein the wearing fixture calculates the position of the wearing fixture on a basis of the communication between the wearing fixture and the communication device, and transmits information related to the calculated position of the wearing fixture to the operation device.

6. The positioning system according to claim 1, wherein the communication device calculates the position of the wearing fixture on a basis of the communication between the wearing fixture and the communication device, and transmits information related to the calculated position of the wearing fixture to the wearing fixture, and the wearing fixture transmits the information related to the position of the wearing fixture received from the communication device to the operation device.

7. The positioning system according to claim 1, wherein the information related to the position of the wearing fixture calculated by the wearing fixture or the communication device is information transmitted to an information processing device together with operation data indicating contents of an operation on the operation device.

8. The positioning system according to claim 7, wherein the information related to the position of the wearing fixture calculated by the wearing fixture or the communication device is information transmitted to the information processing device in a state included in a data area preliminarily defined in the operation data.

9. A wearing fixture that is worn by a user and is capable of communicating with an operation device held by the user and a communication device arranged apart from the user, wherein
a position of the wearing fixture is calculated on a basis of the communication between the wearing fixture and the communication device, and
information related to the calculated position of the wearing fixture is transmitted to the operation device.

10. A positioning method performed in a positioning system including a wearing fixture that is worn by a user and is capable of communicating with an operation device held by the user, and a communication device that is capable of wirelessly communicating with the wearing fixture and is arranged apart from the user, wherein the wearing fixture or the communication device calculates a position of the wearing fixture on a basis of the communication between the wearing fixture and the communication device, and the wearing fixture transmits information related to the position of the wearing fixture calculated by the wearing fixture or the communication device to the operation device.
